(19) United States
(12) Patent Application Publication
(10) Pub. No.: US 2003/0217615 A1
(43) Pub. Date: Nov. 27, 2003

(54) Handlebar safety device

(76) Inventors: Rajiv Arvindakshan Menon, Wallingford, PA (US); Kristy Bittenbender Arbogast, Media, PA (US); Flaura Koplin Winston, Narberth, PA (US)

Correspondence Address: Mathews, collins, Shepherd & McKay, P.A., Suite 306, 100 Thanet Circle, Princeton, NJ, 08540, US

(21) Appl. No.: 10/154,140

(22) Filed: May 22, 2002

(51) Int. Cl. B62K 21/12

(52) U.S. Cl. 74/551.8

(57) ABSTRACT

The present invention relates to a handlebar safety device which attaches to a handlebar. The handlebar safety device comprises a sleeve which is received over the handlebar. A bias member retainer housing is coupled to one end of the sleeve and an end cap is coupled to the other end of the sleeve. A bias member biases the bias member retainer housing from the end cap. Upon impact of the rider with the handlebar safety device, the bias member compresses and absorbs energy generated by impact of the rider. If the impact force is greater than a predetermined amount, the bias member retainer housing can fail or break to prevent the bias member from rebounding into the rider. For example, the frame can be a bicycle frame or a frame for other forms of personal transportation and toys that are pushed or ridden.

### BACKGROUND OF THE INVENTION

1. Field of the Invention

The present invention relates to a handlebar safety device which attaches to a handlebar and absorbs force upon impact of the rider with the handlebar.

2. Description of the Related Art

It is known that life threatening truncal injuries in children are caused by impact with a handlebar in slow speed bicycling crashes. A consequential injury that may result from such a handlebar accident is a traumatic abdominal wall hernia (TAWH). A TAWH is produced by a direct blow that is either blunt or may impact the skin with an insufficient force to puncture the skin. A TAWH occurs because the elasticity of the skin is greater than the other layers of the abdominal wall. The skin remains intact despite the fact that there may be significant disruption below the abdominal wall, i.e., muscle and fascia, thus causing difficulty in detection. In the worst case scenario, bicycle handlebar trauma can cause death. Bicycle handlebar trauma is often hard to detect initially in a clinical atmosphere and may be further complicated by delayed injury.

One particular form of accident is responsible for the majority of these injuries. This involves a rapid shift in momentum caused by the front tire of the bicycle coming into contact with a changing interface such as the transition from sidewalk to grass. This transition stops the bicycle and tends to rotate the front wheel and handlebars. The rider continues to move forward into an end of the handlebar and often hits the ground with the handlebar end still in contact with his/her abdomen. On impact, an additional blow is exerted by the handlebar on the rider, which is translated into the rider's abdominal area.

It is desirable to provide a handlebar safety device which can be attached to a handlebar and absorbs energy generated by the impact of the rider with the handlebar and prevents rebound of the handlebar into the rider after impact.

### SUMMARY OF THE INVENTION

The present invention relates to a handlebar safety device which attaches to a handlebar. The device can be retrofit to a conventional handlebar or built-in to the handlebar. The handlebar safety device comprises a sleeve which is received over the handlebar. A bias member retainer housing is coupled to one end of the sleeve and an end cap is coupled to the other end of the sleeve. A bias member biases the bias member retainer housing from the end cap. Upon impact of the rider with the handlebar safety device, the bias member compresses and absorbs energy generated by impact of the rider. If the impact force is greater than a predetermined amount, the bias member retainer housing can fail or break to prevent the bias member from rebounding into the rider. Accordingly, the handlebar safety device avoids rebound under excessive force/high loads and prevents failure under lower loads. For example, the frame can be a bicycle frame or a frame for other forms of personal transportation and toys that are pushed or ridden.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a longitudinal sectional view of an end of the safety handlebar in an uncompressed condition according to the present invention; and

FIG. 2 is a longitudinal sectional view of the end of the handlebar in a compressed condition according to the present invention.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

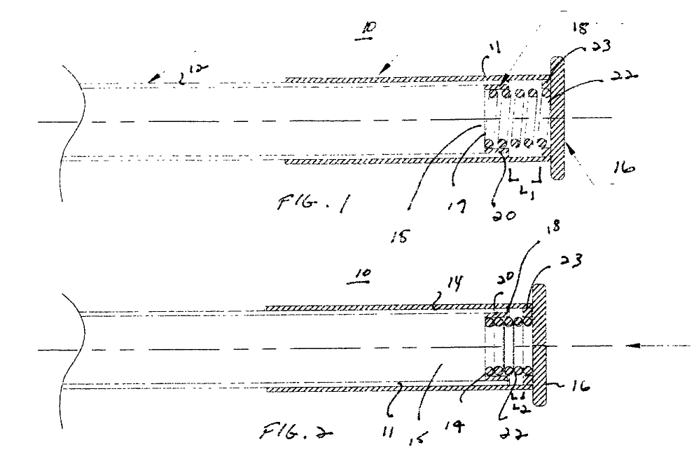

FIGS. 1 and 2 illustrate handlebar safety device 10 in accordance with the teachings of the present invention. Handlebar safety device 10 is coupled to a handlebar 12. Handlebar 12 can be a conventional tubular handlebar used on a bicycle including but not limited to a single, continuous bent tube, and could be used on other forms of personal transportation and toys that are pushed or ridden. Non-limiting examples of personal transportation and toys include tricycles, scooters, pogo sticks, motorcycles, mopeds, dirt bikes, all terrain vehicles, jet skis, motor-scooters and razor scooters. A grip handle (not shown) is typically coupled to an end of handlebar 12 and is gripped by the rider. The grip handle can be removed for allowing handlebar safety device 10 to be retrofitted to handlebar 12. Alternatively, handlebar 12 can be manufactured with handlebar safety device 10.

Handlebar safety device 10 comprises sleeve 14. Sleeve 14 is coupled to end cap 16 and bias member retainer housing 18. End cap 16 and bias member retainer housing 18 can be integral with sleeve 14. Alternatively, bias member retainer housing 18 can be removably coupled to sleeve 14. Sleeve 14 is slidably received over outer end 11 of handlebar 12. For example, sleeve 14 can be formed of flexible material which can slide over handlebar 12 upon receipt of force by a user coupling sleeve 14 to handlebar 12 or upon impact, as described below, and can remain in place after placement on handlebar 12. Bias member retainer housing 18 comprises bottom 19 and side wall 20. Bottom 19 and side wall 20 can be integral with one another in a cap configuration. Upon sliding sleeve 14 over outer end of handlebar 12, bias member retainer housing 18 fits within cavity 15 of outer end 11 of handlebar 12 and side wall 20 of bias member retainer housing 18 is adjacent inner wall 21 of outer end 11 of handlebar 12. Suitable materials for sleeve 14 include flexible plastic, rubber or a nylon spandex material. It will be appreciated that sleeve 14 can be formed of other conventional flexible or expandable materials.

End cap 16 can be formed of a compressible material to distribute and cushion the impact of force to end cap 16. Suitable materials for end cap 16 include rubber or foam rubber and other compressible materials known to those skilled in the art.

Bias member 22 is operatively associated with retainer member 23 of end cap 16 and bottom 19 of bias member retainer housing 18 for biasing end cap 16 away from bias member retainer housing 18. During normal use, bias member 22 is in an uncompressed state, as shown in FIG. 1. It will be appreciated by those skilled in the art that bias member 22 can be partially compressed in a normal state. For example, bias member 22 can be a helical spring which is in the range of about 1 to about 3 inches in length in an uncompressed state. Although those skilled in the art will appreciate that bias member 22 can be longer or shorter than the range of about 1 to about 3 inches when in an uncompressed state. Suitable materials for bias member 22 include metal or plastic.

Upon impact of force with end cap 16, bias member 22 is compressed, as shown in FIG. 2B. Distance L₂ between bias member retainer housing 18 and end cap 16, in the compressed state of bias member 22, is less than distance L1 between bias member retainer housing 18 and end cap 16 in the uncompressed state. If the impact of force with end cap 16 is greater than a predetermined amount, referred to as “excessive force,” bias member retainer housing 18 can fail or break to allow bias member retainer housing 18 and bias member 22 to move within handlebar 12 in the direction of arrow A. For example, during failure of bias member retainer housing 18, bottom 19 of bias member retainer housing 18 can break off from side wall 20.

Upon compression, bias member 22 stores a portion of the energy of impact. This energy is released upon breakage of bias member retainer housing 18. The energy stored in bias member 22 during compression acts to extend and propel bias member 22 in the direction of arrow A. Thereafter, upon failure of bias member retainer housing 18, end cap 16 is prevented from springing back towards the rider and causing additional harm to the rider. The material of bias member retainer housing 18 can be selected as a material which will fail after application of a known amount of force. For example, bias member retainer housing 18 can be formed of plastic and can fail after application of force of greater than about 6000 lbs/inch. Alternatively, bias member retainer housing can be formed of rubber. In one embodiment after failure, the failed bias member retainer housing 18 can be removed from sleeve 14 and replaced with a replacement bias member retainer housing 18. Original bias member 22 can be used with replacement bias member retainer housing 18.

It is to be understood that the above-described embodiments are illustrative of only a few of the many possible specific embodiments which can represent application of the principles of the invention. Numerous and varied other arrangements can be readily devised in accordance with these principles by those skilled in the art without departing from the spirit and scope of the invention.

What is claimed is:

1. A handlebar safety device comprising:
a sleeve adapted to be slidably received on a handlebar;
a bias member retainer housing coupled to a first end of said sleeve, said bias member retainer housing adapted to be received in a cavity of an outer end of said handlebar;
an end cap coupled to a second end of said sleeve; and
a bias member operatively associated with said bias member retainer housing and said end cap for biasing said bias member retainer housing away from said end cap and absorbing energy during impact of said end cap.

2. The handlebar safety device of claim 1 wherein upon application of excessive force said bias member retainer housing breaks and said bias member moves within said cavity.

3. The handlebar safety device of claim 1 wherein said bias member retainer housing is removably coupled to said sleeve.

4. The handlebar safety device of claim 1 wherein said bias member is a helical spring.

5. The handlebar safety device of claim 1 wherein said bias member retainer housing and said end cap are integral with said sleeve.

6. The handlebar safety device of claim 1 wherein said bias member retainer housing is formed of plastic or rubber.

7. The handlebar safety device of claim 1 wherein said bias member retainer housing can fail after application of a force of 6000 lbs/in.

8. The handlebar safety device of claim 1 wherein said end cap is formed of a compressible material.

9. The handlebar safety device of claim 8 wherein said end cap is formed of rubber or foam rubber.

10. The handlebar safety device of claim 1 wherein said sleeve is formed of flexible plastic, rubber or nylon spandex.

11. The handlebar of claim 1 wherein said handlebar frame is part of a bicycle.

12. The handlebar of claim 1 wherein said handlebar frame is attached or integral to a tricycle, scooter, pogo-stick, motorcycle, moped, dirt bike, all terrain vehicle, jet ski, motor scooter or razor scooter.

13. A handlebar safety device comprising:
a sleeve adapted to be slidably received on a handlebar;
a bias member retainer housing coupled to a first end of said sleeve, said bias member retainer housing receivable in a cavity of an outer end of said handlebar;
an end cap coupled to a second end of said sleeve; and
a bias member operatively associated with said bias member retainer housing and said end cap for biasing said bias member retainer housing away from said end cap and absorbing energy during impact of said end cap,
wherein upon said application of excessive force said bias member retainer housing breaks and said bias member moves within said cavity.

14. The handlebar safety device of claim 13 wherein said bias member is a helical spring.

15. The handlebar safety device of claim 13 wherein said bias member retainer housing is removably coupled to said sleeve.

16. The handlebar safety device of claim 13 wherein said bias member retainer housing and said end cap are integral with said sleeve.

17. A method for reducing impact of a handlebar comprising the steps of:
providing a sleeve adapted to be slidably received on a handlebar, a bias member retainer housing coupled to a first end of said sleeve and an end cap coupled to a second end of said sleeve;
operatively associating a bias member with said bias member retainer housing and said end cap for biasing said bias member retainer housing away from said end cap and absorbing energy during impact of said end cap;
receiving said bias member retainer housing in a cavity of an outer end of said handlebar; and
sliding said sleeve over said handlebar.

18. The method of claim 17 wherein upon application of excessive force said bias member retainer housing breaks and said bias member moves within said cavity.

19. The method of claim 17 wherein said bias member is a helical spring.

20. The method of claim 17 wherein said bias member retainer housing is removably coupled to said sleeve.

21. The method of claim 17 wherein said bias member retainer housing and said end cap are integral with said sleeve.

22. The method of claim 21 wherein said bias member retainer housing is formed of plastic or rubber.

23. The method of claim 17 wherein said bias member retainer housing can fail after application of a force of 6000 lbs/in.

24. The method of claim 17 wherein said end cap is formed of a compressible material.

25. The method of claim 24 wherein said end cap is formed of rubber or foam rubber.

26. The method of claim 17 wherein said sleeve is formed of flexible plastic, rubber or nylon spandex.

27. The method of claim 17 wherein said handlebar frame is part of a bicycle.

28. The method of claim 17 wherein said handlebar frame is attached or integral to a tricycle, scooter, pogo-stick, motorcycle, moped, dirt bike, all terrain vehicle, jet ski, motor scooter or razor scooter.

29. The method of claim 17 further comprising the step of:
removing a grip handle from said handlebar before said step of sliding said sleeve over said handlebar.
